(19) United States
(12) Patent Application Publication
(10) Pub. No.: US 2006/0040140 A1
(43) Pub. Date: Feb. 23, 2006

(54) Magnetic recording medium and magnetic recording/reproducing apparatus

(75) Inventors: Akimasa Kaizu, Chuo-ku (JP); Katsumichi Tagami, Chuo-ku (JP); Kazuya Shimakawa, Chuo-ku (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 11/200,487

(22) Filed: Aug. 10, 2005

(30) Foreign Application Priority Data
Aug. 23, 2004 (JP) 2004-242647

(51) Int. Cl. G11B 5/667; G11B 5/66

(52) U.S. Cl. 428/829; 428/828.1

(57) ABSTRACT

A perpendicular recording type, magnetic recording medium having a soft magnetic layer and a magnetic recording/reproducing apparatus including such a magnetic recording medium are provided. The magnetic recording medium allows the recording magnetic field to be efficiently applied to a track for recording while restricting the extent of the recording magnetic field. The magnetic recording medium has a soft magnetic layer and a recording layer formed in this order on a substrate. The soft magnetic layer has its part on the opposite side to the substrate formed in a concavo-convex pattern. The recording layer is oriented to have magnetic anisotropy in the direction perpendicular to the surface. A fixing layer for fixing the magnetic anisotropy of the soft magnetic layer in a predetermined direction parallel to the surface is provided between the recording layer and the soft magnetic layer.

### BACKGROUND OF THE INVENTION

1. Field of the Invention

The present invention relates to a perpendicular recording type magnetic recording medium including a soft magnetic layer and a magnetic recording/reproducing apparatus.

2. Description of the Related Art

The areal densities of conventional magnetic recording media such as a hard disk have been greatly increased as the size of magnetic grains forming the recording layers has been reduced, different materials have been used, and the heads have come to be more precisely processed. Development of perpendicular recording type magnetic recording media for practical use is underway in which a recording layer is oriented to have magnetic anisotropy perpendicular to the surface and a soft magnetic layer is formed under the recording layer, so that the areal density is increased.

In the perpendicular recording type magnetic recording medium, the soft magnetic layer attracts the recording magnetic field from the recording head of the magnetic head and forms a return path for the recording magnetic field applied from the main magnetic pole of the recording head to the recording layer to return to a return magnetic pole. The main magnetic pole and the return magnetic pole are arranged side by side in the circumferential direction of the tracks in which the magnetic head (relatively) moves. The recording magnetic field mainly penetrates through the soft magnetic layer in the circumferential direction of the tracks and returns from the main magnetic pole to the return magnetic pole.

It is preferable that in order to provide good recording/reproducing characteristics, the soft magnetic layer acts to linearly enhance the recording magnetic field, and the magnetization of the soft magnetic layer is removed as the recording magnetic field is removed. However, the soft magnetic layer sometimes has the magnetic anisotropy that causes the magnetization by the recording magnetic field to remain in a particular direction. The recording magnetic field penetrates through the soft magnetic layer mainly in the circumferential direction of the tracks as described above. Therefore, if the soft magnetic layer has the magnetic anisotropy which causes the magnetization by the recording magnetic field to remain in the circumferential direction of the tracks, the magnetization in the circumferential direction caused by the recording magnetic field remains even after the recording magnetic field is removed. This may cause noises or the like during reproducing data. Furthermore, a magnetic domain is sometimes generated in the soft magnetic layer, and the magnetization can be in inverted state on both sides of the magnetic domain wall. In this case, spike-like noises could be generated during reproducing to cause errors. Therefore, an anti-ferromagnetic layer is normally provided at the soft magnetic layer on the substrate side, and the soft magnetic layer has its magnetic anisotropy fixed in the width direction of the tracks which is substantially perpendicular to the main component substantially parallel to the medium surface of the recording magnetic field in the medium and parallel to the medium surface In this way, the remanent magnetization by the recording magnetic field from the recording head is reduced.

As described above, the areal densities of the magnetic recording media have continued to be increased and their further improvements are expected in the future. Meanwhile, disadvantages such as processing limitations for the magnetic heads, recording to track adjacent to the target track caused by the expansion of the magnetic recording field of the magnetic head and crosstalk during reproducing have come to be known. Therefore, improvements in the areal densities according to the conventional method have their limit and there have been proposed magnetic recording media that may allow further improvements in the areal densities such as a discrete track medium and a patterned medium. In such media, a recording layer is formed in a predetermined concavo-convex pattern (see for example Japanese Patent Laid-Open Publication No. Hei 7-129953). The discrete track medium or patterned medium is preferably a perpendicular recording type medium in order to increase the areal density.

The perpendicular recording provides improvements in the areal density to some extent, but the soft magnetic layer continuously formed under the recording layer causes the recording magnetic field to be attracted not only to a track for recording but also to a part adjacent to the track. More specifically, the extent of the recording magnetic field increases, which reduces or cancels the improvement in the areal density provided by the perpendicular recording.

### SUMMARY OF THE INVENTION

In view of the foregoing problems, various exemplary embodiments of this invention provide a perpendicular recording type magnetic recording medium including a soft magnetic layer that allows the recording magnetic field to be efficiently applied to a track for recording while restricting the extent of the recording magnetic field and a magnetic recording/reproducing apparatus including such a magnetic recording medium.

The above described object is achieved by various exemplary embodiments of the invention according to which at least the part of the soft magnetic layer on the opposite side to the substrate is formed in a concavo-convex pattern, and a fixing layer for fixing the magnetic anisotropy of the soft magnetic layer in a predetermined direction substantially parallel to the surface is provided between the recording layer and the soft magnetic layer.

The above described object is achieved by various exemplary embodiments of the invention according to which at least the part of the soft magnetic layer on the opposite side to the substrate is formed in a concavo-convex pattern, and a high coercive force layer made of a high coercive force material is provided between the recording layer and the soft magnetic layer and/or between the substrate and the soft magnetic layer. The high coercive force layer has coercive force higher than that of the soft magnetic layer and applies a magnetic field to the soft magnetic layer in a predetermined direction substantially parallel to the surface.

The above described object is achieved by various exemplary embodiments of the invention according to which at least the part of the soft magnetic layer on the opposite side to the substrate is formed in a concavo-convex pattern, and the concave portion of the soft magnetic layer is filled with a high coercive force material. The high coercive force material has coercive force higher than that of the soft magnetic layer and applies a magnetic field to the soft magnetic layer in a predetermined direction substantially parallel to the surface.

In the process of conceiving the invention, the inventors experimentally formed a soft magnetic layer in a concavo-convex pattern. They assumed that localizing the convex portion of the soft magnetic layer under the tracks might restrict the extent of the recording magnetic field. Note that in this case, an anti-ferromagnetic layer was provided only on the substrate side of the soft magnetic layer as was often practiced by the conventional method.

When however the soft magnetic layer was thus actually formed into a concavo-convex pattern, the recording characteristic changes every time data was recorded or a large spike-like noise that could cause errors during reproducing was generated. In addition, the random noise level increased. This was probably because of change in the direction of the magnetic anisotropy of the soft magnetic layer caused as the soft magnetic layer was processed to have the concavo-convex pattern. More specifically, a soft magnetic layer tends to obtain magnetic anisotropy in the length-wise direction when it is processed to have an elongate shape. Therefore, when the soft magnetic layer is formed into a concavo-convex pattern, the convex part of the soft magnetic layer obtains magnetic anisotropy in the length-wise direction, i.e., in the circumferential direction of the tracks. In other words, it is believed that when the soft magnetic layer is controlled to have magnetic anisotropy in the width direction of the tracks by the anti-ferromagnetic layer provided on its substrate side, the convex portion in the concavo-convex pattern of the soft magnetic layer is provided with magnetic anisotropy in the circumferential direction of the tracks. This causes large magnetization from the recording magnetic field to remain in the soft magnetic layer even after the recording magnetic field is removed. It is believed that this changed the recording characteristic every time data was recorded or a magnetic domain was generated in some magnetization pattern of the recording layer to cause a spike-like noise, and the random noise component increased.

The inventors have conducted further studies and completed one aspect of the invention according to which a fixing layer is provided on the recording layer side of soft magnetic layer. The fixing layer is provided to fix the magnetic anisotropy of the soft magnetic layer in a direction substantially perpendicular to the main component of the recording magnetic field parallel to the medium surface in the medium and substantially parallel to the medium surface. The inventors have made another aspect of the invention according to which a high coercive force layer is provided between the recording layer and the soft magnetic layer and/or between the substrate and the soft magnetic layer. The high coercive force layer is formed to provide the soft magnetic layer with a magnetic field substantially perpendicular to the main component of the recording magnetic field (that is parallel to the surface of the medium) in the medium and substantially parallel to the surface of the medium. The inventors have made yet another aspect of the invention according to which the concave portion of the soft magnetic layer is filled with a high coercive force material. The coercive force material provides the soft magnetic layer with a magnetic field substantially perpendicular to the main component of the recording magnetic field (that is parallel to the surface of the medium) in the medium and substantially parallel to the surface of the medium.

When, for example, the main component of the recording magnetic field parallel to the surface of the medium in the medium is directed in the circumferential direction that equals the length-wise direction of the tracks, the fixing layer provided on the recording layer side of the soft magnetic layer allows the magnetic anisotropy of the convex portion of the soft magnetic layer to be fixed in the width direction of the tracks perpendicular to the length-wise direction. In this way, the remanent magnetization at the soft magnetic layer originated from the recording magnetic field can be reduced. Alternatively, the high coercive force layer or material is magnetized to constantly apply a magnetic field to the soft magnetic layer in the width direction of the tracks, so that the remanent magnetization at the soft magnetic layer originated from the recording magnetic field can be reduced. Consequently, large remanent magnetization by the recording magnetic field or a magnetic domain in the soft magnetic layer after the removal of the recording magnetic field can be reduced, and the spike-like noise and the like can be reduced.

Accordingly, various exemplary embodiments of the invention provide

a magnetic recording medium, comprising:

a substrate;

a soft magnetic layer having at least a part thereof on a side opposite to the substrate formed in a predetermined concavo-convex pattern;

a recording layer oriented to have magnetic anisotropy in a direction perpendicular to a surface, the soft magnetic layer and the recording layer being formed in this order over the substrate; and

a fixing layer, provided between the recording layer and the soft magnetic layer, for fixing magnetic anisotropy of the soft magnetic layer in a predetermined direction substantially parallel to the surface.

Alternatively, various exemplary embodiments of the invention provide

a magnetic recording medium, comprising:

a substrate;

a soft magnetic layer having at least a part thereof on a side opposite to the substrate formed in a predetermined concavo-convex pattern;

a recording layer oriented to have magnetic anisotropy in a direction perpendicular to a surface, the soft magnetic layer and the recording layer being formed in this order over the substrate; and

a high coercive force layer provided between the recording layer and the soft magnetic layer and/or between the substrate and the soft magnetic layer to apply a magnetic field to the soft magnetic layer in a predetermined direction substantially parallel to the surface, the high coercive force layer being formed of a high coercive force material having greater coercive force than that of the soft magnetic layer.

Moreover, various exemplary embodiments of the invention provide

a magnetic recording medium, comprising:

a substrate;

a soft magnetic layer having at least a part thereof on a side opposite to the substrate formed in a predetermined concavo-convex pattern;

a recording layer oriented to have magnetic anisotropy in a direction perpendicular to a surface, the soft magnetic layer and the recording layer being formed in this order over the substrate; and

a high coercive force material filled within a concave portion in the soft magnetic layer to apply a magnetic field to the soft magnetic layer in a predetermined direction substantially parallel to the surface, the high coercive force material having greater coercive force than that of the soft magnetic layer.

Note that in this application, the “soft magnetic layer having at least a part thereof on a side opposite to the substrate formed in a predetermined concavo-convex pattern” shall refer to a soft magnetic layer having continuously formed convex and concave portions that follow to the pattern of tracks in the recording layer as well as a soft magnetic layer having partly continuous convex portions in a region other than a concave portion (convex region) and a soft magnetic layer having convex portions completely divided from one another.

Furthermore, in this application, the “recording layer divided into a plurality of recording elements in a concavo-convex pattern” shall refer to a recording layer having (convex) recording elements completely divided from one another as well as a recording layer having partly continuous recording elements in a region other than a concave portion (convex region) and a recording layer having a recording element continuously formed over a part of the substrate in a helical form.

Furthermore, in this application, the term “magnetic recording medium” shall refer not only to a hard disk, a floppy disk, a magnetic tape, or the like but also to a magneto-optical recording medium such as an MO (Magneto Optical) disc that uses both magnetism and light and a thermally assisted type recording medium that uses both magnetism and heat.

### BRIEF DESCRIPTION OF THE DRAWINGS

FIG. 1 is a schematic perspective view of the structure of a main part of a magnetic recording/reproducing apparatus according to a first exemplary embodiment of the invention;

FIG. 2 is an enlarged, schematic sectional side view taken in the radial direction showing the structure of a magnetic recording medium in the magnetic recording/reproducing apparatus;

FIG. 3 is a schematic sectional side view showing the magnetic anisotropy of a soft magnetic layer, a first fixing layer, and a second fixing layer in the magnetic recording medium;

FIG. 4 is a schematic perspective view of the structure of a magnetic head in the magnetic recording/reproducing apparatus;

FIG. 5 is a schematic sectional side view showing the step of annealing in the process of manufacturing the magnetic recording medium;

FIG. 6 is a horizontal sectional view of FIG. 5;

FIG. 7 is a schematic sectional side view showing the magnetic anisotropy of a soft magnetic layer, a first fixing layer, and a second fixing layer in a magnetic recording medium according to a second exemplary embodiment of the invention;

FIG. 8 is an enlarged, schematic sectional side view of the structure of a magnetic recording medium according to a third exemplary embodiment of the invention taken in the radial direction;

FIG. 9 is a schematic sectional side view showing the magnetic anisotropy of a soft magnetic layer and a ferromagnetic material in the magnetic recording medium;

FIG. 10 is an enlarged, schematic sectional side view of the structure of a magnetic recording medium according to a fourth exemplary embodiment of the invention taken in the radial direction;

FIG. 11 is an enlarged, schematic sectional side view of the structure of a magnetic recording medium according to a fifth exemplary embodiment of the invention taken in the radial direction;

FIG. 12 is an enlarged, schematic sectional side view-of the structure of a magnetic recording medium according to a sixth exemplary embodiment of the invention taken in the radial direction;

FIG. 13 is an enlarged, schematic sectional side view of the structure of a magnetic recording medium according to a seventh exemplary embodiment of the invention taken in the radial direction;

FIG. 14 is a graph showing in comparison the ranges of the minimum values of external disturbing magnetic fields that cause spike-like noise in the magnetic recording media in the Working Example and the Comparative Example;

FIG. 15 is a graph showing the relation between the depth of the concave portion in the magnetic-recording medium and the extent of the magnetic field in the Simulation Examples according to the exemplary embodiments of the invention; and

FIG. 16 is a graph showing the relation between the ratio of the part of the soft magnetic layer that forms the bottom part of the concave portion relative to the total thickness of the soft magnetic layer in the magnetic recording medium and the intensity of the recording magnetic field on the top surface of a recording element.

### DETAILED DESCRIPTION OF THE PREFERRED EMBODIMENT

Various exemplary embodiments of this invention will be hereinafter described in detail with reference to the drawings.

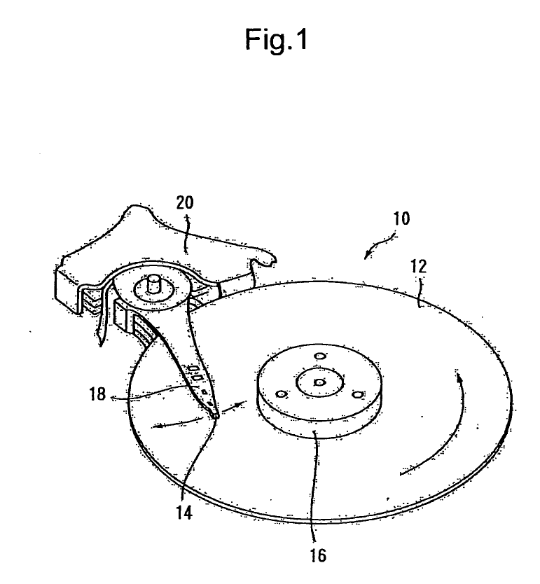

As shown in FIG. 1, a magnetic recording/reproducing apparatus 10 according to a first exemplary embodiment of the invention includes a magnetic recording medium 12, and a magnetic head 14 for recording/reproducing data to/from the magnetic recording medium 12 and is characterized by the structure of the magnetic recording medium 12. Other part of the structure that is not considered to be particularly necessary for understanding this exemplary embodiment of the invention will be appropriately omitted.

Now, the magnetic recording medium 12 is fixed to a chuck 16 and rotatable with the chuck 16. The magnetic head 14 is mounted in the vicinity of the tip of an arm 18 which is pivotably provided at a base 20. In this way, the magnetic head 14 can move closely to the surface of the magnetic recording medium 12 in a circular route in the radial direction of the magnetic recording medium 12.

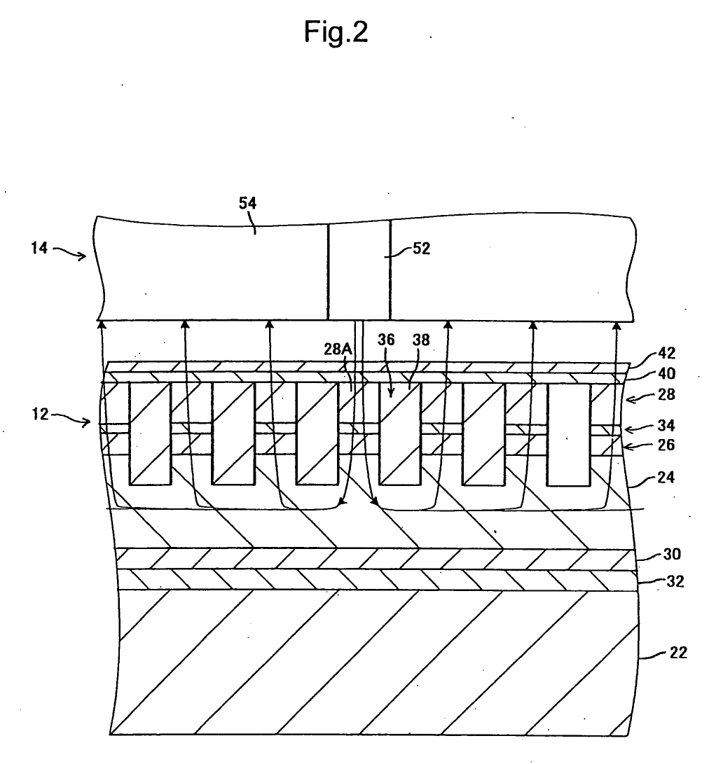

The magnetic recording medium 12 is a discrete track type magnetic disk based on perpendicular recording. As shown in FIG. 2, a soft magnetic layer 24 and a recording layer 28 are formed in this order over a substrate 22. The part of the soft magnetic layer 24 opposite side to the substrate 22 is in a concavo-convex pattern. The recording layer 28 is oriented to have magnetic anisotropy in the direction perpendicular to the surface and divided into a plurality of recording elements 28A in the concavo-convex pattern. A first fixing layer 26 for fixing the magnetic anisotropy of the soft magnetic layer 24 in the radial direction of the magnetic recording medium 12 (a predetermined direction parallel to the surface) that equals the width direction of the tracks is provided between the recording layer 28 and the soft magnetic layer 24. Note that the recording elements 28A are in concentric track shapes at very small intervals in the radial direction in a data region, and FIG. 2 is a sectional side view of the elements taken in the radial direction. The recording elements 28A are in a patterned shape for predetermined servo information in a servo region (not shown).

The magnetic recording medium 12 has a second fixing layer 30 in contact with the surface of the soft magnetic layer 24 on the side of the substrate 22 to fix the magnetic anisotropy of the soft magnetic layer 24 in the radial direction.

The substrate 22 has its surface on the side of the soft magnetic layer 24 mirror-polished. The substrate 22 may be made of a non-magnetic material such as glass, Si, and Al₂O₃, an Al alloy coated with NiP.

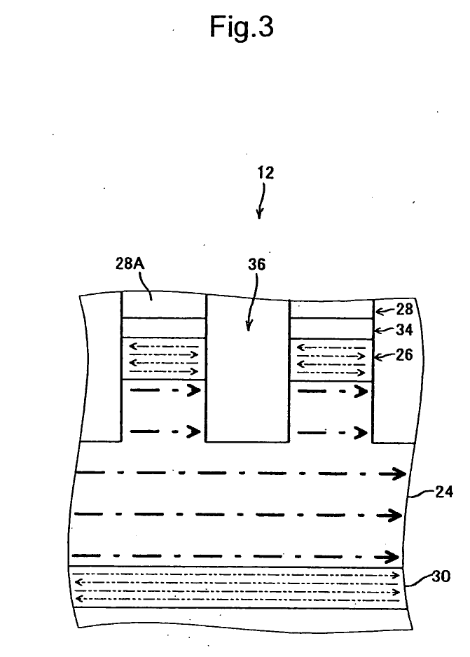

The soft magnetic layer 24 has a thickness of 50 to 300 nm. The magnetic layer 24 may be made of a material such as an Fe (iron) alloy, a Co (cobalt) amorphous alloy, or ferrite. Note that the soft magnetic layer 24 may have a layered structure including a layer having soft magnetic and a non-magnetic layer. The soft magnetic layer 24 has radial magnetic anisotropy as denoted by the chain-dotted arrows in FIG. 3. Note that the part of the soft magnetic layer 24 forming the bottom of the concave portion 36 preferably has a thickness equal to at least 50% of the total thickness of the soft magnetic layer 24. The depth of the concave portion 36 in the soft magnetic layer 24 is preferably in the range of from 3 nm to 25 nm.

The first fixing layer 26 has a thickness of 5 to 50 nm and is divided in the same concavo-convex pattern as that of the recording layer 28. The first fixing layer 26 may be made of an anti-ferromagnetic material such as an FeMn alloy, a PtMn alloy, an IrMn alloy, and a NiO oxide film and the like. The first fixing layer 26 has radial magnetic anisotropy as denoted by the chain double-dotted arrows in FIG. 3. More specifically, in the fixing layer 26, the magnetic moments of the anti-ferromagnetic material are in anti parallel alignment in the radial direction as denoted by the chain double-dotted arrows in FIG. 3. The first fixing layer 26 is in contact with the surface of the convex portion of the soft magnetic layer 24 on the side of the recording layer 28. The part of the soft magnetic layer 24 on the side of the recording layer 28 is exchange-coupled with the first fixing layer 26 and has its magnetic anisotropy fixed in the radial direction.

The second fixing layer 30 has a thickness of 5 to 50 nm. Like the first fixing layer 26, the second fixing layer 30 may also be made of an anti-ferromagnetic material such as an FeMn alloy, a PtMn alloy, an IrMn alloy, and a NiO oxide film and the like. In the second fixing layer 30, the anti-ferromagnetic material also has magnetic moments in anti parallel alignment in the radial direction as denoted by the chain double-dotted arrows in FIG. 3. The second fixing layer 30 is in contact with the surface of the soft magnetic layer 24 on the side of the substrate 22. The part of the soft magnetic layer 24 on the side of the substrate 22 is exchange-coupled with the second fixing layer 30 and has its magnetic anisotropy fixed in the radial direction.

An underlayer 32 is formed between the substrate 22 and the second fixing layer 30. The underlayer 32 has a thickness of 2 to 40 nm. The underlayer 32 may be made, for example, of Ta.

The recording layer 28 has a thickness of 5 to 30 nm. The material of the recording layer 28 may be a CoCr-based alloy such as a CoCrPt alloy, an FePt-based alloy, and a layered structure of them, or an oxide-based material such as SiO₂ including ferromagnetic grains such as CoPt and the like in a matrix.

A seed layer 34 which orients the recording layer 28 to have magnetic anisotropy in the thickness direction (perpendicularly to the surface) of the recording layer 28 is provided between the recording layer 28 and the first fixing layer 26. The seed layer 34 has a thickness of 2 to 40 nm. The material of the seed layer 34 may be, for example, a non-magnetic CoCr alloy, Ti, Ru, a layered structure of Ru and Ta, or MgO.

The concave portion 36 in the concavo-convex pattern is filled with a non-magnetic material 38 to the surface of the recording layer 28 on the opposite side to the substrate 22. The non-magnetic material 38 may be oxide such as SiO₂, Al₂O₃, TiO₂, and ferrite, nitride such as AlN, or carbide such as SiC.

A protective layer 40 and a lubricating layer 42 are formed in this order over the recording element 28A and the non-magnetic material 38. The protective layer 40 has a thickness of 1 to 5 nm. The protective layer 40 may be made, for example, of a hard carbon film called diamond-like carbon and the like. Note that in the application, the term “diamond-like carbon” (hereinafter simply as “DLC”) shall refer to a material mainly composed of carbon in an amorphous structure and having a hardness about in the range of from 2×10⁹ Pa to 8×10¹⁰ Pa in Vickers hardness measurement. The lubricating layer 42 has a thickness of 1 to 2 nm. The material of the lubricating layer 42 may be fluorine containing material such as PFPE (perfluoropolyether).

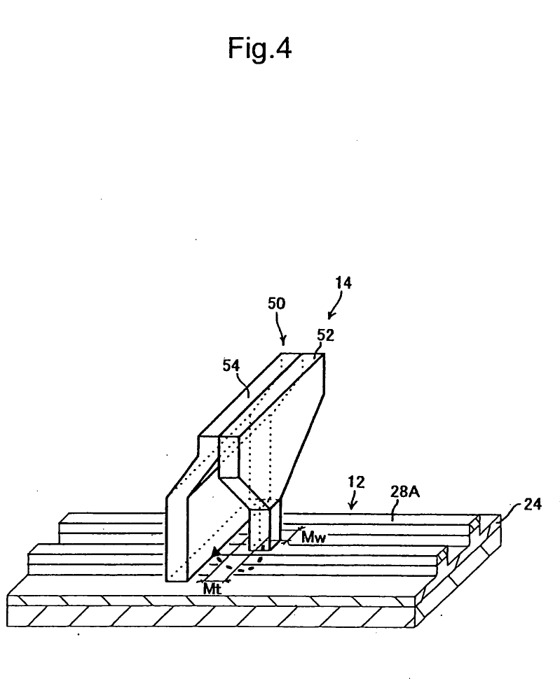

The magnetic head 14 includes a recording head 50 as shown in FIG. 4. The recording head 50 includes a main magnetic pole 52 and a return magnetic pole 54. The main magnetic pole 52 and the return magnetic pole 54 are arranged side by side in the (relative) moving direction of the magnetic head 14, i.e., in the circumferential direction of the tracks of the magnetic recording medium 12. In this way, a recording magnetic field generated by the main magnetic pole 52 penetrates through the soft magnetic layer 24 of the magnetic recording medium 12 mainly in the circumferential direction of the tracks and is returned to the return magnetic pole 54. Note that the magnetic head 14 also includes a reproducing head that is not shown in FIG. 4. FIG. 4 shows only the recording elements 28A and the soft magnetic layer 24 regarding the magnetic recording medium 12 for the ease of understanding the arrangement of the magnetic head 14 and the magnetic recording medium 12.

Now, the operation of the magnetic recording/reproducing apparatus 10 will be described.

The magnetic recording medium 12 has the soft magnetic layer 24 in a concavo-convex pattern, so that the extent of the recording magnetic field is restricted, and the recording magnetic field from the main magnetic pole 52 is attracted to the target recording element 28A on the convex portion of the soft magnetic layer 24 as denoted by the arrows in FIG. 2.

The first fixing layer 26 is provided on the soft magnetic layer 24 on the side of the recording layer 28. Therefore, although the soft magnetic layer 24 is formed in a concavo-convex pattern and the part of the soft magnetic layer 24 on the side of the recording layer 28 forms a convex portion extending in the circumferential direction of the tracks, the magnetic anisotropy of the part is fixed in the radial direction, not in the circumferential direction of the tracks that equals the lengthwise direction. (The radial direction corresponds to a direction substantially perpendicular to the main component of the recording magnetic field substantially parallel to the surface of the medium in the medium and parallel to the surface of the medium.)

The second fixing layer 30 is provided on the soft magnetic layer 24 on the side of the substrate 22, so that the magnetic anisotropy of the part of the soft magnetic layer 24 on the side of the substrate 22 is also fixed in the radial direction, not in the lengthwise, circumferential direction. Therefore, in the soft magnetic layer 24, large remanent magnetization or a magnetic domain associated with the recording magnetic field after the end of the recording process can be reduced, so that spike-like noises and the like can be reduced.

The magnetic recording medium 12 does not suffer from problem such as recording to track adjacent to target track, crosstalk between neighboring tracks at the time of reproducing even if the areal density is high because the recording elements 28A are formed in a track shape in the data region.

In the magnetic recording medium 12, the recording elements 28A are separated from each other and there is no recording layer 28 at the concave portion 36 between the recording elements 28A. Therefore, noises are not caused from the concave portion 36. This also results in good recording/reproducing characteristics.

In the magnetic recording medium 12, the concave portion 36 between the recording elements 28A is filled with the non-magnetic material 38, and the step between the concave and convex parts on the surface is small. Therefore, the flying height of the magnetic head 14 is stable. This also results in good recording/reproducing characteristics.

According to the conventional techniques, it is believed that in order to efficiently apply a recording magnetic field to the recording layer, the soft magnetic layer must be provided as closely as possible to the recording layer. It has been generally considered that the layer that fixes the direction of the magnetic anisotropy of the soft magnetic layer must be provided on the substrate side of the soft magnetic layer. In contrast, in the magnetic recording medium 12, the soft magnetic layer 24 is formed to have a concavo-convex pattern, so that the recording magnetic field is concentrated on the recording element. The first fixing layer 26 is provided on the recording layer 28 side of the soft magnetic layer 24, so that the magnetic anisotropy of the soft magnetic layer 24 is surely fixed in the radial direction that is the width direction of the tracks. (The radial direction corresponds to a direction substantially perpendicular to the main component of the recording magnetic field parallel to the medium surface in the medium and substantially parallel to the surface of the medium.) In this way, noises caused by remanent magnetization or a magnetic domain in the soft magnetic layer 24 originated from the recording magnetic field after the removal of the recording magnetic field can be reduced. This is based on a totally different concept from the conventional techniques.

Now, a method of producing the magnetic recording medium 12 will briefly be described.

The underlayer 32, the second fixing layer 30, the soft magnetic layer 24, the first fixing layer 26, the seed layer 34, a continuous recording layer (recording layer 28 yet to be processed) are formed over the substrate 22 in this order by sputtering and the like, and the resulting structure is spin-coated with a resist layer. In this way, an object to be processed is produced.

Now, a concavo-convex pattern for the tracks in the data region and a servo pattern in the servo region is transferred to the resist layer by nano-imprinting process. The resist layer, the continuous recording layer, the seed layer 34, the first fixing layer 26, and the soft magnetic layer 24 at the bottom of the concave portion are removed by dry etching. Then, the concave portion 36 is formed to the soft magnetic layer 24. In this way, the continuous recording layer is divided into a number of recording elements 28A, and the seed layer 34 and the first fixing layer 26 are divided in the same pattern. Note that one or more mask layers may be provided between the continuous recording layer and the resist layer, and the continuous recording layer and the like may be divided by a plurality of dry etching steps.

Then, for example by sputtering process, a non-magnetic material 38 is deposited on the surface of the object to be processed to fill the concave portion 36 between the recording elements 28A therewith. Thereafter, the object to be processed may be irradiated with a process gas obliquely by ion-beam etching while the object to be processed is turned. In this way, the excess part of the non-magnetic material 38 above the recording layer 28 is removed, and the surface is flattened. Then, the protective layer 40 is deposited by CVD and the lubricating layer 42 is applied by dipping.

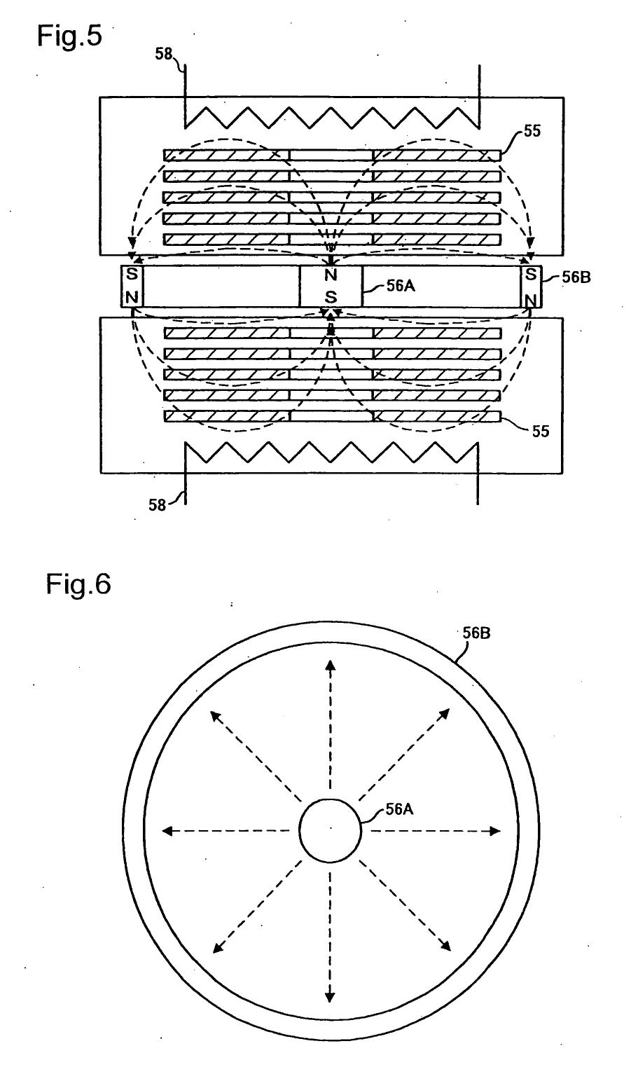

The object to be processed is then held in an annealing furnace, a magnet 56A is provided in the center of the object to be processed 55 and a magnet 56B arranged with its polarity in opposite direction to the magnet 56A is provided at the outer circumference of the object to be processed 55 as shown in FIGS. 5 and 6. The magnets 56A and 56B may be a rare earth magnet such as NdFeB. Note that the reference numeral 58 in FIG. 5 refers to a heater. The object to be processed 55 is heated to a temperature higher than the blocking temperature for the first and second fixing layers 26 and 30, and then a radial external magnetic field in the radial direction of the object to be processed 55 is applied by the magnets 56A and 56B upon the object to be processed 55. Then the object to be processed 55 is slowly cooled as the external magnetic field is applied, magnetic anisotropy is provided in the radial direction of the soft magnetic layer 24, the first fixing layer 26, and the second fixing layer 30. At the same time, exchange coupling between the first fixing layer 26 and the soft magnetic layer 24 and exchange coupling between the second fixing layer 30 and the soft magnetic layer 24 fix the magnetic anisotropy of the soft magnetic layer 24 in the radial direction. In this way, the above-described magnetic recording medium 12 is obtained.

Note that the magnetic recording medium 12 has its recording elements 28A formed in a pattern of predetermined servo information in the servo region, and therefore application of a homogeneous magnetic field in the thickness direction of the magnetic recording medium 12 allows the servo information to be readily recorded in the magnetic recording medium 12.

Now, a second exemplary embodiment of the invention will be described.

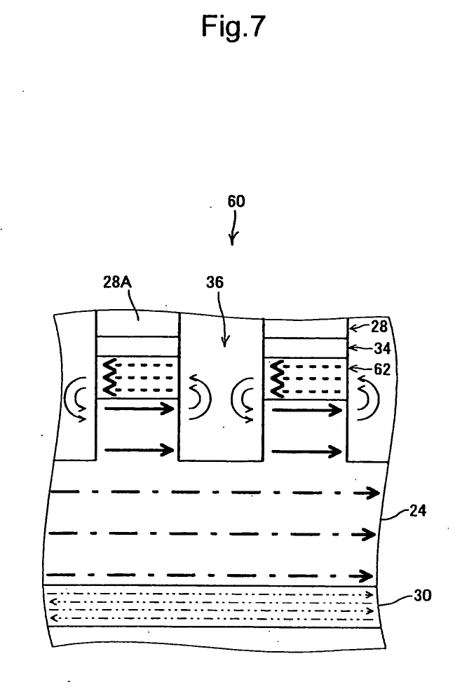

As shown in FIG. 7, as compared to the magnetic recording medium 12 according to the first exemplary embodiment, a magnetic recording medium 60 according to the second exemplary embodiment includes a high coercive force layer 62 made of a material having coercive force higher than that of the soft magnetic layer 24 instead of the first fixing layer 26 of the anti-ferromagnetic material. The high coercive force layer 62 is provided to apply a magnetic field to the soft magnetic layer 24 in the radial direction that equals the width direction of the tracks. (The radial direction corresponds to a direction substantially perpendicular to the main component of the recording magnetic field parallel to the medium surface in the medium and substantially parallel to the medium surface.) Note that the high coercive force layer 62 has higher coercive force than that of the recording layer 28. The other structure is the same as that of the magnetic recording medium 12 and therefore the description will be omitted.

The high coercive force layer 62 has a thickness of 10 to 50 nm and is divided in the same concavo-convex pattern as that of the recording layer 28. The material of the high coercive force layer 62 may be, for example, a CoPt alloy, a CoPtTa alloy, an FePt alloy, or a Co-doped Fe₂O₃ alloy and the like. The high coercive force layer 62 is provided between the convex portion of the soft magnetic layer 24 and the recording layer 28 and magnetized inwardly in the radial direction as denoted by the dotted arrows in FIG. 7. In this way, a magnetic field directed outwardly in the radial direction is applied to the part of the soft magnetic layer 24 on the side of the recording layer 28 as denoted by the solid arrows in FIG. 7. Note that the high coercive force layer 62 may be magnetized outwardly in the radial direction and a magnetic field directed inwardly in the radial direction may be applied on the soft magnetic layer 24.

Similarly to the magnetic recording medium 12 according to the first exemplary embodiment, in the magnetic recording medium 60, the extent of the recording magnetic field is restricted, and the recording magnetic field from the main magnetic pole 52 is attracted to the target recording element 28A on the convex portion of the soft magnetic layer 24. Furthermore, the high coercive force layer 62 applies the magnetic field to the soft magnetic layer 24 in the radial direction, i.e., the width direction of the tracks. Therefore, even though the soft magnetic layer 24 is formed in the concavo-convex pattern and the part of the soft magnetic layer 24 on the side of the recording layer 28 has an elongate convex shape in the circumferential direction of the tracks, large remanent magnetization or a magnetic domain in the soft magnetic layer 24 associated with the recording magnetic field after the removal of the recording magnetic field after the end of the recording process can be reduced. Consequently, spike-like noises and the like can be reduced.

Note that the high coercive force layer 62 has coercive force greater than that of the recording layer 28, and therefore when data is recorded by applying a recording magnetic field smaller than the coercive force of the high coercive force layer 62 to the recording layer 28, the direction of magnetization of the high coercive force layer 62 and the direction of the magnetic anisotropy of the soft magnetic layer 24 are not affected by the recording magnetic field.

When servo information is recorded in the magnetic recording medium 12, a recording magnetic field smaller than the coercive force of the high coercive force layer 62 is applied to the magnetic recording medium 12 evenly in the thickness direction. In this way, the direction of magnetization of the high coercive force layer 62 and the direction of the magnetic anisotropy of the soft magnetic layer 24 are not affected by the recording magnetic field.

Now, a method of manufacturing the magnetic recording medium 60 will briefly be described. Note that the method of manufacturing the recording medium 60 is the same as the method of manufacturing the magnetic recording medium 12 with essential difference being that the high coercive force layer 62 must be magnetized in the radial direction. Therefore, the description of the other same part will be appropriately omitted.

Similarly to the method of manufacturing the magnetic recording medium 12, an object to be processed having a protective layer 40 and a lubricating layer 42 is held in an annealing furnace, and magnets arranged with polarities thereof in opposite direction each other are provided in the center and at the outer circumference of the object to be processed. An external magnetic field is applied to the object to be processed in the heated state, then the object to be processed is slowly cooled as the external magnetic field continues to be applied, and the magnetic anisotropy of the second fixing layer 30 is fixed in the radial direction. In this way, the soft magnetic layer 24 has its magnetic anisotropy fixed in the radial direction by exchange coupling with the second fixing layer 30.

Then, using an electromagnet that generates an external magnetic field greater than the coercive force of the high coercive force layer 62 (about 1.5 times as large), a magnetic field in the radial direction (inward) is applied to the object to be processed, while the object to be processed is rotated at least for a turn for magnetization in the radial direction. In this way, as shown in FIG. 7, a magnetic field is applied by the high coercive force layer 62 to the soft magnetic layer 24 in the radial direction that equals the width direction of the tracks, and the magnetic recording medium 60 is obtained.

Now, a third exemplary embodiment of the invention will be described.

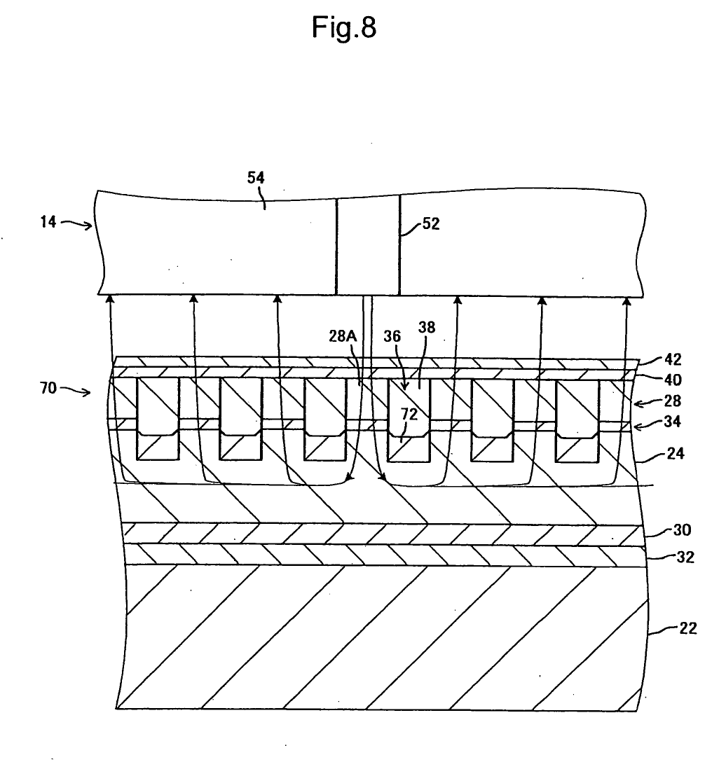

As shown in FIG. 8, a magnetic recording medium 70 according to the third exemplary embodiment of the invention is different from the magnetic recording medium 12 according to the first exemplary embodiment in that a high coercive force material 72 to apply a magnetic field to the soft magnetic layer 24 in the radial direction i.e., the width direction of the tracks is filled in the concave portion 36 of the soft magnetic layer 24. (The radial direction corresponds to a direction substantially perpendicular to the main component of the recording magnetic field parallel to the medium surface in the medium and substantially parallel to the medium surface.) The high coercive force material 72 has greater coercive force than those of the soft magnetic layer 24 and the recording layer 28: Note that there is no first fixing layer on the recording layer 28 side of the soft magnetic layer 24. The other structure is the same as that of the magnetic recording medium 12 and therefore the description will not be repeated.

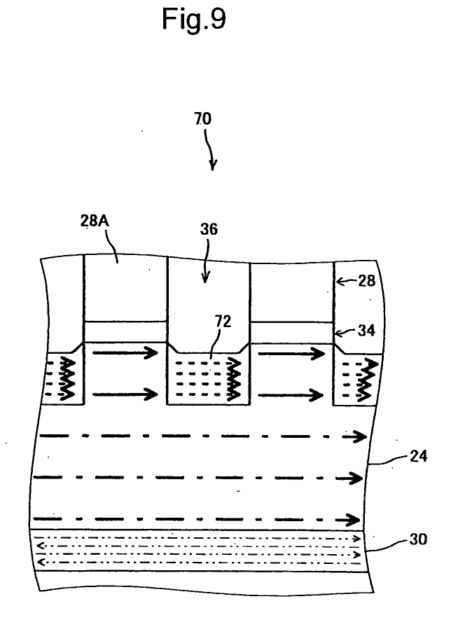

The high coercive force material 72 is filled in the concave portion 36 to the level near the boundary between the soft magnetic layer 24 and the seed layer 34. Note that the part above the high coercive force material 72 in the concave portion 36 is filled with the non-magnetic material 38. The high coercive force material 72 may be for example a CoPt alloy, a CoPtTa alloy, an FePt alloy, or a Co-doped Fe₂O₃ alloy and the like. As denoted by the dotted arrows in FIG. 9, the high coercive force material 72 is magnetized outwardly in the radial direction. In this way, an outward magnetic field in the radial direction is constantly applied to the part of the soft magnetic layer 24 on the side of the recording layer 28 as denoted by the solid arrows as shown in FIG. 9. Note that the high coercive force material 72 may be magnetized inwardly in the radial direction, and an inward magnetic field in the radial direction may be applied to the soft magnetic layer 24.

Similarly to the magnetic recording medium 12 according to the first exemplary embodiment, in the magnetic recording medium 70, the extent of the recording magnetic field is restricted, the recording magnetic field from the main magnetic pole 52 is attracted to the target recording element 28A on the convex portion of the soft magnetic layer 24. Furthermore, the high coercive force material 72 applies the magnetic field to the soft magnetic layer 24 in the radial direction that equals to the width direction of the tracks. Therefore, even though the soft magnetic layer 24 is formed in the concavo-convex pattern and the part of the soft magnetic layer 24 on the side of the recording layer 28 has an elongate convex shape in the circumferential direction of the tracks, large remanent magnetization or a magnetic domain in the soft magnetic layer 24 associated with the recording magnetic field after the removal of the recording magnetic field after the end of the recording process can be reduced. Consequently, spike-like noises and the like can be reduced.

Note that the high coercive force material 72 has coercive force greater than that of the recording layer 28, and therefore when data is recorded by applying a recording magnetic field larger than the coercive force of the recording layer 28 and smaller than the coercive force of the high coercive force material 72 to the recording layer 28, the direction of the magnetic anisotropy of the high coercive force material 72 and that of the soft magnetic layer 24 are not affected by the recording magnetic field.

When the servo information is recorded in the magnetic recording medium 12, a recording magnetic field smaller than the coercive force of the high coercive force material 72 is applied to the magnetic recording medium 12 evenly in the thickness direction, so that the direction of magnetization of the high coercive force material 72 and the direction of the magnetic anisotropy of the soft magnetic layer 24 are not affected by the recording magnetic field.

Now, a method of manufacturing the magnetic recording medium 70 will briefly be described.

Similarly to the magnetic recording medium 12 according to the first exemplary embodiment, the underlayer 32, the second fixing layer 30, the soft magnetic layer 24, the seed layer 34, and a continuous recording layer (recording layer 28 yet to be processed) are produced in this order on the substrate 22 by sputtering or the like. The resulting structure is spin-coated with a resist layer. Note that the first fixing layer is not formed. Then, a concavo-convex pattern is transferred to the resist layer by nano-imprinting process,, and the continuous recording layer, the seed layer 34, and the soft magnetic layer 24 at the bottom of the concave portion are removed by dry etching, and a concave portion 36 is formed to reach the soft magnetic layer 24.

Then, the high coercive force material 72 is deposited on the surface of the object to be processed by sputtering or the like, then the concave portion 36 is filled near the level of the boundary between the soft magnetic layer 24 and the seed layer 34, and then a non-magnetic material 38 is deposited on the high coercive force material 72 to completely fill the concave portion 36 between the recording elements 28A. Then, the object to be processed may be irradiated with a process gas obliquely by ion-beam etching while the object to be processed is turned, so that the excess part of the high coercive force material 72 and the non-magnetic material 38 above the recording layer 28 is removed away and the surface is flattened. Then, the protective layer 40 is deposited by CVD or the like and the lubricating layer 42 is applied by dipping.

Then, the object to be processed is heated to a temperature higher than the blocking temperature for the second fixing layer 30, and a radial external magnetic field is applied by magnets to the object to be processed. As the external magnetic field continues to be applied, the object to be processed is slowly cooled. Then, the second fixing layer 30 is provided with magnetic anisotropy in the radial direction, and the soft magnetic layer 24 has its magnetic anisotropy fixed in the radial direction by exchange coupling with the second fixing layer 30.

Then, using an electromagnet that generates an external magnetic field greater than the coercive force of the high coercive force material 72 (at least about 1.5 times as large), a magnetic field in the radial direction (outward) is applied to the object to be processed, while the object to be processed is rotated at least for a turn for magnetization in the radial direction. In this way, as shown in FIG. 9, the magnetic field is applied by the high coercive force material 72 to the soft magnetic layer 24 in the radial direction that equals the width direction of the tracks, and the above-described magnetic recording medium 70 is obtained.

Note that according to the first to third exemplary embodiments, in the magnetic recording/reproducing apparatus 10, the main magnetic pole 52 and the return magnetic pole 54 of the magnetic head 14 are arranged side by side in the circumferential direction of the tracks, so that the recording magnetic field penetrates through the soft magnetic layer 24 of the magnetic recording medium 12 in the circumferential direction of the tracks. Therefore, in order to reduce the remanent magnetization in the circumferential direction of the tracks in the soft magnetic layer 24 caused by the recording magnetic field, the first and second fixing layers 26 and 30 are provided with radial magnetic anisotropy. The high coercive force layer 62 and the high coercive force material 72 are magnetized in the radial direction. However, depending on the structure of the magnetic recording/reproducing apparatus, the direction of the magnetic anisotropy of the first and second fixing layers and the magnetization direction of the high coercive force layer 62 and the high coercive force material 72 may be appropriately set in a direction substantially perpendicular to the main component of the recording magnetic field parallel to the medium surface in the medium and substantially parallel to the medium surface.

For example, according to the first to third exemplary embodiments, the magnetic medium 12 is in a disk shape. However, when the magnetic recording/reproducing apparatus includes a rectangular plate shaped, magnetic recording medium, and a magnetic head that applies a recording magnetic field that penetrates through the soft magnetic layer in the direction parallel to a side of the magnetic recording medium, the first and second fixing layers may be provided with magnetic anisotropy in the direction perpendicular to the side and substantially parallel to the surface of the medium. The high coercive force layer 62 and the high coercive force material 72 may be magnetized in a direction substantially perpendicular to the side and substantially parallel to the surface of the medium.

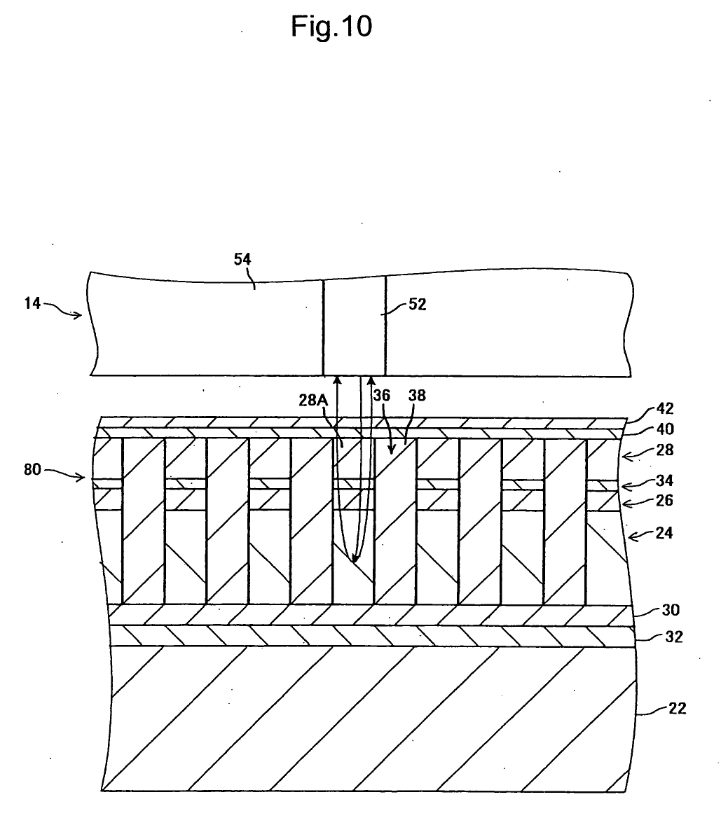

According to the first to third exemplary embodiments, the concave portion 36 in the concavo-convex pattern of the recording layer 28 is formed partway of the thickness of the soft magnetic layer 24. However, for example as in the magnetic recording medium 80 according to a fourth exemplary embodiment shown in FIG. 10, the concave portion 36 in the concavo-convex pattern in the recording layer 28 may be formed all the way to the surface of the soft magnetic layer 24 on the side of the substrate 22, and the soft magnetic layer 24 may completely be divided.

According to the first to fourth exemplary embodiments, the underlayer 32 and the second fixing layer 30 are formed between the substrate 22 and the soft magnetic layer 24, but the arrangement of the layers between the substrate 22 and the soft magnetic layer 24 may be changed depending on the kind of the magnetic recording medium or various needs. Alternatively, the underlayer 32 may be omitted. When the first fixing layer 26, the high coercive force layer 62, and the high coercive force material 72 fix the magnetic anisotropy of the convex portion of the soft magnetic layer 24 in the radial direction, and sufficient magnetic anisotropy is provided to the soft magnetic layer 24, the second fixing layer 30 may be omitted.

The arrangement of the layers between the first fixing layer 26 and the recording layer 28 is not particularly limited, and for example the recording layer 28 may be formed directly on the first fixing layer 26 while the seed layer 34 is omitted.

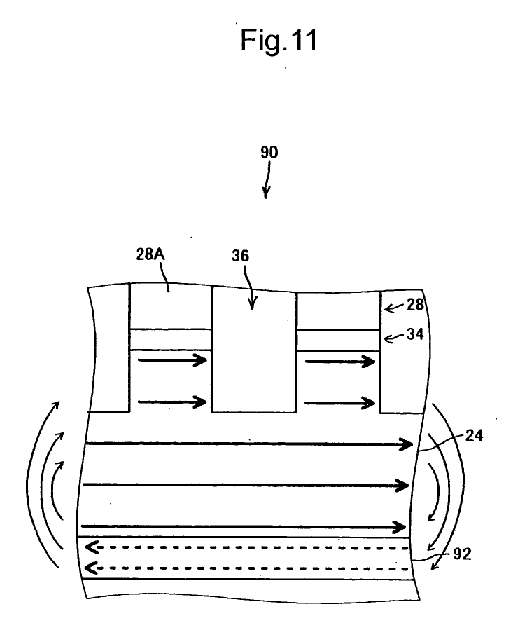

According to the second exemplary embodiment, the high coercive force layer 62 is provided between the soft magnetic layer 24 and the recording layer 28, but as in a magnetic recording medium 90 according to a fifth exemplary embodiment of the invention as shown in FIG. 11, a continuous high coercive force layer 92 may be provided between the soft magnetic layer 24 and the substrate 22. Note that the second fixing layer 30 is not necessary in this case, and therefore the annealing step is not necessary in the manufacturing process.

According to the first to fifth exemplary embodiments, the non-magnetic material 38 is SiO₂, but the non-magnetic material 38 is not specified as long as the material is non-magnetic.

According to the first to fifth exemplary embodiments, the concave portion 36 between the recording elements 28A is filled with the non-magnetic material 38, but the concave portion 36 may be hollow as long as a good flying characteristic can be obtained for the magnetic head 14.

According to the first to fifth exemplary embodiments, the magnetic recording media 12, 60, 70, 80, and 90 each have the recording layer 28 and the like over one side of the substrate 22, but the invention is applicable to a double-sided magnetic recording medium having a recording layer over both sides of the substrate.

According to the first to fifth exemplary embodiments, the magnetic recording media 12, 60, 70, 80, and 90 are each a discrete track type magnetic disk having recording elements 28A arranged side by side at very small intervals in the radial direction of the tracks in the data region. Meanwhile, it is understood that the invention is applicable to a magnetic disk having recording elements arranged side by side at very small intervals in the circumferential direction (sector direction) of the tracks, a magnetic disk having recording elements arranged at very small intervals both in the radial and circumferential directions of the tracks, and a magnetic disk having a spiral track. The invention is also applicable to a magneto-optical disc such as an MO, a thermally assisted type magnetic disk that uses both magnetism and heat, and other magnetic recording media other than in a disk shape having a recording layer in a concavo-convex pattern such as a magnetic tape.

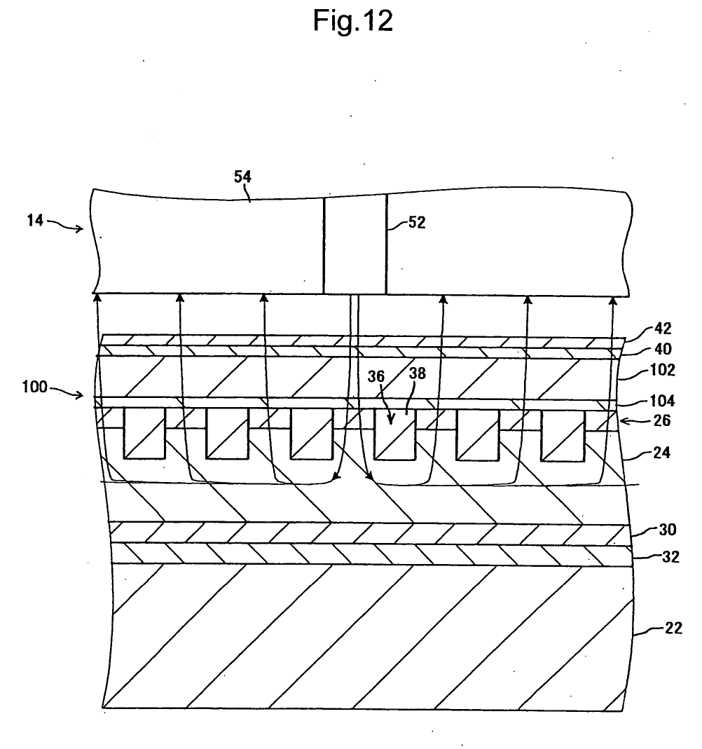

Furthermore, the invention is applicable to a magnetic recording medium 100 as in a sixth exemplary embodiment of the invention as shown in FIG. 12 that includes a continuous recording layer 102 and a seed layer 104 instead of the divided recording layer 28 and the divided seed layer 34 of the magnetic recording medium 12 according to the first exemplary embodiment. In this case, the first fixing layer 26 may be in a continuous shape. A divided or continuous high coercive force layer as in the second exemplary embodiment may be provided instead of the first fixing layer 26.

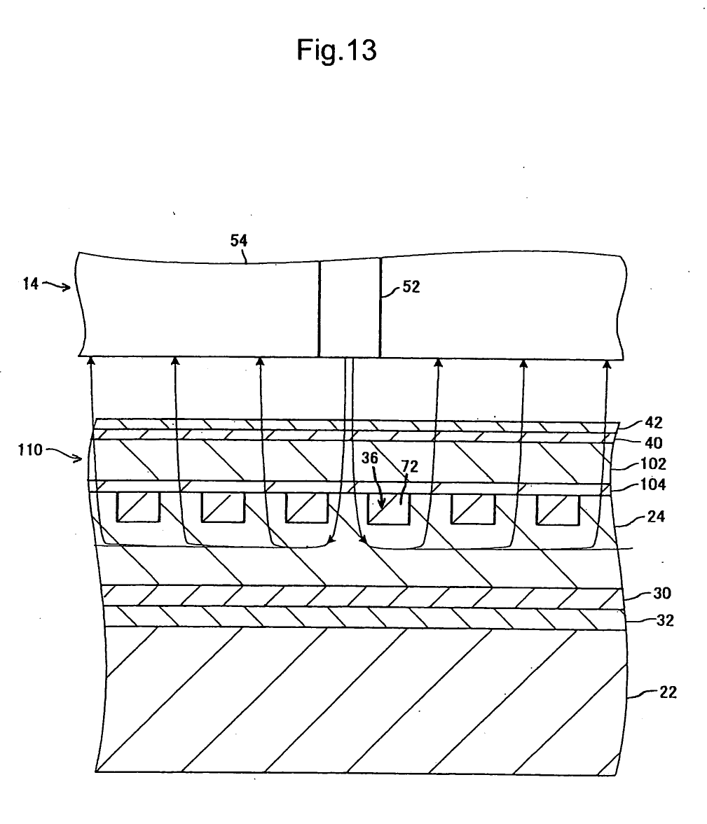

In addition, the invention is applicable to a magnetic recording medium 110 as in a seventh exemplary embodiment as shown in FIG. 13 that includes a continuous recording layer 102 and a continues seed layer 104 instead of the divided recording layer 28 and the divided seed layer 34 of the magnetic recording medium 70 according to the third exemplary embodiment.

### WORKING EXAMPLE

Ten magnetic recording media 12 were manufactured according to the first exemplary embodiment. The specific structure of the magnetic recording media 12 will be described below.

The substrate 22 had a diameter of about 25.4 mm (1 inch) and was made of glass. The underlayer 32 was about as thick as 10 nm and made of Ta. The second fixing layer 30 was about as thick as 20 nm and made of a PtMn alloy. The soft magnetic layer 24 was about as thick as 100 nm and made of a CoZrNb alloy. The first fixing layer 26 was about as thick as 10 nm and made of a PtMn alloy. The seed layer 34 was about as thick as 10 nm and made of Ru. The recording layer 28 was about as thick as 20 nm and made of SiO₂ and CoPt crystal particles in a mixed crystalline phase. The non-magnetic material 38 was SiO₂. The protective layer 40 was about as thick as 4 nm and made of DLC. The lubricating layer 42 was about as thick as 1 nm and made of a fluorine containing lubricant.

The track pitch was 150 nm, the width of the recording element 28A was 100 nm, and the width of the concave portion 36 was 50 nm. The concave portion 36 was formed partway of the thickness of the soft magnetic layer 24 so that the bottom of the concave portion 36 was positioned 10 nm apart from the top surface of the soft magnetic layer 24.

While the magnetic recording media 12 were heated at about 250° C. in an annealing furnace, a magnetic field at about 30 kA/m was applied for about 20 minutes in the radial direction followed by slow cooling. In this way, the soft magnetic layer 24, the first fixing layer 26, and the second fixing layer 30 were provided with radial magnetic anisotropy.

A recording magnetic field was applied to the magnetic recording media 12 thus provided with the magnetic anisotropy in a state free from external disturbing magnetic fields and data is recorded to the media.

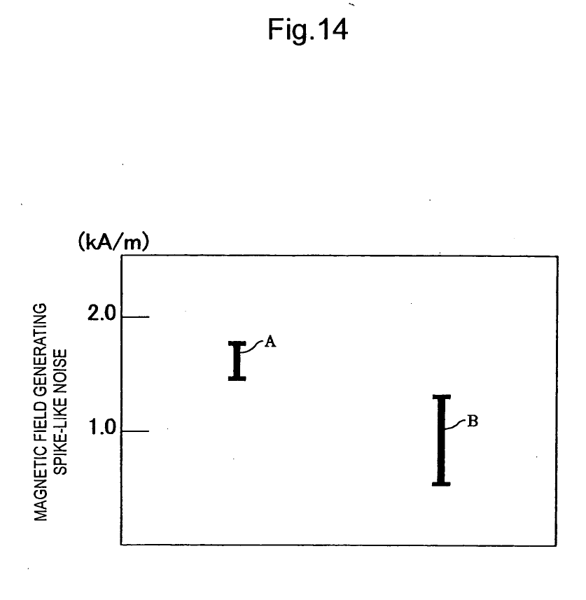

Then, a sufficiently small external disturbing magnetic field was applied to these magnetic recording media 12, then the presence/absence of spike-like noise was sequentially checked while the magnitude of the disturbing magnetic field was gradually increased and the magnitude of the external disturbing magnetic field was measured when a spike-like noise was detected for the first time. Herein, the “spike-like noise” refers to a spike like output larger than the average of the envelope of the output for one track cycle. This is detected by the reproducing head mainly for domain wall between magnetic domains having inverted magnetization from one another generated in the soft magnetic layer. In FIG. 14, a letter A denotes the range of the magnitude of the external disturbing magnetic field when the spike-like noise was detected for the first time in the ten magnetic recording media 12.

Note that to apply a external disturbing magnetic field to the magnetic recording media 12, a magnetic field generating device for generating magnetic fields in random directions with AC current was used. The intensity of the magnetic field from the magnetic field generating device was previously measured in the position of each magnetic recording medium 12, and the AC magnetic field intensity was adjusted by adjusting the current intensity. In a recording/reproducing evaluation device, the spike-like noise was measured as required while the AC magnetic field intensity was adjusted.

### COMPARATIVE EXAMPLE

Ten magnetic recording media were produced by omitting the first fixing layer 26 from the Working Example described above. The other structure was the same as that of the Practical Example.

The magnitudes of external disturbing magnetic fields when the spike-like noise was detected for the first time were measured for these magnetic recording media in the same manner as the Working Example. In FIG. 14, the line denoted by a letter B represents the range of the magnitude of the external disturbing magnetic field when the spike-like noise was detected for the first time in the ten magnetic recording media.

As shown in FIG. 14, it was confirmed that even when a magnetic domain was easy to form by random magnetic fields, the magnitude of the external disturbing magnetic fields when the first spike-like noise was detected was greater in the Working Example than in the Comparative Example, about twice as large at most. It was also confirmed that the range of the magnitude of the external disturbing magnetic field varied less in the Working Example than in the Comparative Example when the first spike-like noise was detected. Stated differently, it was confirmed that the magnetic recording media 12 according to the Working Example suffer less spike like noises caused by external disturbing magnetic fields than the magnetic recording media in the Comparative Example do and that they have higher reliability. It is believed that this is because the magnetic recording media 12 in the Working Example have the first fixing layer 26 and the magnetic anisotropy of the soft magnetic layer 24 is firmly fixed in the radial direction. Therefore, the remanent magnetization based on the recording magnetic field after the removal of the recording magnetic field reduced more in the magnetic recording media according to the Working Example than the Comparative Example.

### SIMULATION EXAMPLE 1

Eight simulation models according to the first exemplary embodiment were produced. Note that these simulation models had concave portions in different depths, and the other structure was the same. The structures of the simulation models are given in Table 1. The depths of the concave portions are shown in Table 2. Note that the main magnetic pole thickness Mt in Table 1 represents the circumferential thickness of the part of the main magnetic pole 52 in the vicinity of the magnetic recording medium 12 as shown in FIG. 4.

TABLE 1

| | | | |
|---|---|---|---|
| Concavo-convex | Width of convex portion | 100 | nm |
| pattern | Width of concave portion | 100 | nm |
| | Track pitch | 200 | nm |
| Recording layer | Magnetic perpendicular | 600 | kA/m |
| | anisotropy field | | |
| | Thickness | 20 | nm |
| | Saturation magnetization | 0.5 | tesla |
| Seed layer | Thickness | 10 | nm |
| First fixing layer | Thickness | 10 | nm |
| Soft magnetic | Initial permeability | 6.3 × 10⁻⁴ | H/m |
| layer | Thickness | 100 | nm |
| Head | Saturation magnetization of main | 2.3 | tesla |
| | magnet pole | | |
| | Magnetomotive force | 0.12 | AT |
| | Main magnetic pole thickness Mt | 200 | nm |
| | Main magnetic pole width Mw | 100 | nm |
| | Flying height | 10 | nm |

TABLE 2

| | | | Simulation example 2 | |
|---|---|---|---|---|
| Concave depth | Concave depth | Simulation example | Ratio of part forming | |
| from top of | in soft magnetic | 1 | concave bottom/total | Recording magnetic |
| recording layer | layer | Extent of recording | thickness of soft magnetic | field intensity at top |
| (nm) | (nm) | magnetic field (nm) | layer (%) | of recording element |
| 0 | 0 | 58.9 | 100 | 1 |
| 40 | 0 | 47.8 | 100 | 1 |
| 43 | 3 | 45.4 | 97 | 1 |
| 45 | 5 | 40.4 | 95 | 1 |
| 55 | 15 | 35.1 | 85 | 1 |
| 65 | 25 | 31.5 | 75 | 0.98 |
| 90 | 50 | 30.4 | 50 | 0.95 |
| 110 | 70 | 30.0 | 30 | 0.88 |
| 140 | 100 | 29.0 | 0 | 0.8 |

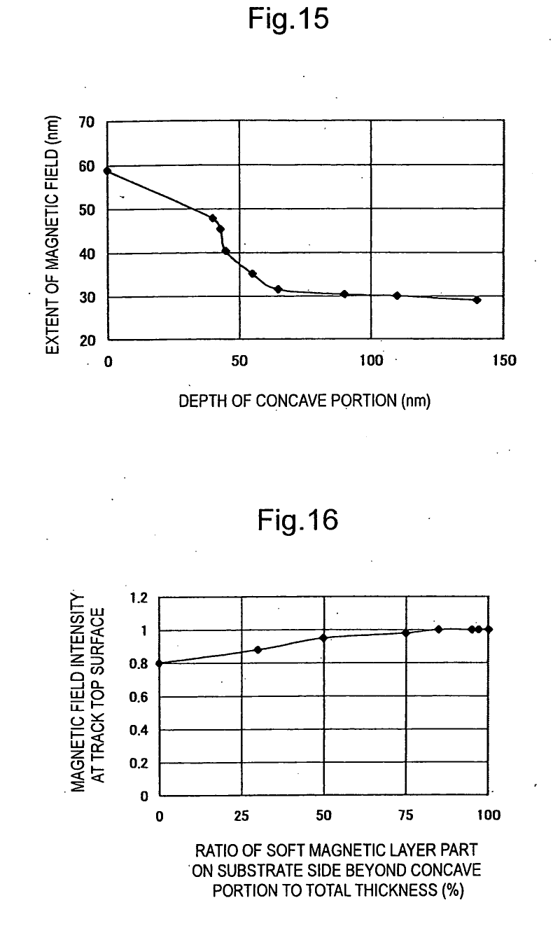

Simulations were run for these simulation models, and the relation between the depth of the concave portion and the extent of the magnetic field as given in Table 2 and FIG. 15 was obtained. Note that the depth of the concave portion refers to the depth from the top surface of the recording elements to the bottom of the concave portion in FIG. 15. The extent of the magnetic field is represented by the distance in the track width direction from the end of the top surface of the recording elements as the reference position to the position where the recording magnetic field intensity is 30% of the recording magnetic field intensity in the center of the recording elements in the track width direction.

As can be seen from Table 2 and FIG. 15, it was confirmed that the extent of the magnetic field tends to be smaller for the deeper concave portions. As shown in FIG. 15, the magnetic field tends to extend less for the deeper concave portions even when no concave is formed in the soft magnetic layer having a depth of 40 nm or less. Meanwhile, when a concave portion is formed in the soft magnetic layer, the extent of the magnetic field is even more reduced. It was confirmed that when the depth of the concave portion is more than 43 nm and a concave portion about as deep as 3 nm is formed in the soft magnetic layer, the extent of the magnetic field is significantly reduced. More specifically, the presence of a concave portion in the soft magnetic layer even for a small depth significantly reduces the extent of the recording magnetic field. It was confirmed that when a concave portion as deep as 3 nm or more is formed in the soft magnetic layer, the advantage of significantly reducing the extent of the recording magnetic field can surely be obtained. Meanwhile, with a concave portion having a depth of about 25 nm or more in the soft magnetic layer, the extent of the recording magnetic field changes little. With too deep a concave portion, the effect of forming a return path is reduced or canceled, and the productivity in the steps of forming the concave portion and filling the concave portion with a non-magnetic material is reduced accordingly. Therefore, the upper limit for the depth of the concave portion in the soft magnetic layer is preferably about 25 nm.

### SIMULATION EXAMPLE 2

Simulations were run for eight simulation models in the Simulation Example 1, and the result representing the relation was obtained between the thickness ratio of the part of the soft magnetic layer that forms the bottom part of the concave portion relative to the total thickness of the soft magnetic layer and the intensity of the recording magnetic field at the top surface of a recording element as shown in Table 2 and FIG. 16. Note that the intensity of the recording magnetic field refers to the intensity of the recording magnetic field in the center in the track width direction of the top surface of the recording element. The magnitude is represented by its ratio relative to the recording magnetic field at the top surface of the recording layer in a simulation model without a concave portion as 1.

The relation between the ratio of the part of the soft magnetic layer that forms the bottom part of the concave portion relative to the total thickness of the soft magnetic layer and the intensity of the recording magnetic field at the top surface of the recording element in the simulation models is shown in Table 2 and FIG. 16. As can be seen from Table 2 and FIG. 16, as the ratio is lower, the intensity tends to be lower. It is believed that this is because the advantage of forming a return path for the recording magnetic field by the part of the soft magnetic layer that forms the bottom part of the concave portion is reduced. As can be seen from FIG. 16, when the ratio is 50% or less, the tendency is much noticeable. Stated differently, it was confirmed that in order to prevent the intensity of the recording magnetic field at the top of the recording element from being reduced, the ratio of the part of the soft magnetic layer that forms the bottom part of the concave portion relative to the total thickness of the soft magnetic layer is preferably not less than 50%.

What is claimed is:

1. A magnetic recording medium, comprising:
a substrate;
a soft magnetic layer having at least a part thereof on a side opposite to the substrate formed in a predetermined concavo-convex pattern;
a recording layer oriented to have magnetic anisotropy in a direction perpendicular to a surface, the soft magnetic layer and the recording layer being formed in this order over the substrate; and
a fixing layer, provided between the recording layer and the soft magnetic layer, for fixing magnetic anisotropy of the soft magnetic layer in a predetermined direction substantially parallel to the surface.

2. The magnetic recording medium according to claim 1, wherein
a material of the fixing layer is an anti-ferromagnetic material.

3. The magnetic recording medium according to claim 1, wherein
when the fixing layer serves as a first fixing layer, a second fixing layer for fixing the magnetic anisotropy of the soft magnetic layer in the predetermined direction is provided between the soft magnetic layer and the substrate.

4. The magnetic recording medium according to claim 2, wherein
when the fixing layer serves as a first fixing layer, a second fixing layer for fixing the magnetic anisotropy of the soft magnetic layer in the predetermined direction is provided between the soft magnetic layer and the substrate.

5. A magnetic recording medium, comprising:
a substrate;
a soft magnetic layer having at least a part thereof on a side opposite to the substrate formed in a predetermined concavo-convex pattern;
a recording layer oriented to have magnetic anisotropy in a direction perpendicular to a surface, the soft magnetic layer and the recording layer being formed in this order over the substrate; and
a high coercive force layer provided between the recording layer and the soft magnetic layer and/or between the substrate and the soft magnetic layer to apply a magnetic field to the soft magnetic layer in a predetermined direction substantially parallel to the surface, the high coercive force layer being formed of a high coercive force material having greater coercive force than that of the soft magnetic layer.

6. A magnetic recording medium, comprising:
a substrate;
a soft magnetic layer having at least a part thereof on a side opposite to the substrate formed in a predetermined concavo-convex pattern;
a recording layer oriented to have magnetic anisotropy in a direction perpendicular to a surface, the soft magnetic layer and the recording layer being formed in this order over the substrate; and
a high coercive force material filled within a concave portion in the soft magnetic layer to apply a magnetic field to the soft magnetic layer in a predetermined direction substantially parallel to the surface, the high coercive force material having greater coercive force than that of the soft magnetic layer.

7. The magnetic recording medium according to claim 5, wherein
the high coercive force material has greater coercive force than that of the recording layer.

8. The magnetic recording medium according to claim 6, wherein
the high coercive force material has greater coercive force than that of the recording layer.

9. The magnetic recording medium according to claim 1, wherein
the recording layer is divided into a plurality of recording elements in the concavo-convex pattern, and a concave portion of the concavo-convex pattern is formed to reach the soft magnetic layer.

10. The magnetic recording medium according to claim 2, wherein
the recording layer is divided into a plurality of recording elements in the concavo-convex pattern, and a concave portion of the concavo-convex pattern is formed to reach the soft magnetic layer.

11. The magnetic recording medium according to claim 3, wherein
the recording layer is divided into a plurality of recording elements in the concavo-convex pattern, and a concave portion of the concavo-convex pattern is formed to reach the soft magnetic layer.

12. The magnetic recording medium according to claim 5, wherein
the recording layer is divided into a plurality of recording elements in the concavo-convex pattern, and a concave portion of the concavo-convex pattern is formed to reach the soft magnetic layer.

13. The magnetic recording medium according to claim 6, wherein
the recording layer is divided into a plurality of recording elements in the concavo-convex pattern, and a concave portion of the concavo-convex pattern is formed to reach the soft magnetic layer.

14. The magnetic recording medium according to claim 7, wherein
the recording layer is divided into a plurality of recording elements in the concavo-convex pattern, and a concave portion of the concavo-convex pattern is formed to reach the soft magnetic layer.

15. A magnetic recording/reproducing apparatus comprising:
the magnetic recording medium according to claim 1; and
a magnetic head for recording/reproducing data to/from the magnetic recording medium.

16. A magnetic recording/reproducing apparatus comprising:
the magnetic recording medium according to claim 2; and
a magnetic head for recording/reproducing data to/from the magnetic recording medium.

17. A magnetic recording/reproducing apparatus comprising:
the magnetic recording medium according to claim 3; and
a magnetic head for recording/reproducing data to/from the magnetic recording medium.

18. A magnetic recording/reproducing apparatus comprising:
the magnetic recording medium according to claim 5; and
a magnetic head for recording/reproducing data to/from the magnetic recording medium.

19. A magnetic recording/reproducing apparatus comprising:
the magnetic recording medium according to claim 6; and
a magnetic head for recording/reproducing data to/from the magnetic recording medium.

20. A magnetic recording/reproducing apparatus comprising:
the magnetic recording medium according to claim 7; and
a magnetic head for recording/reproducing data to/from the magnetic recording medium.
